(19) United States
(12) Patent Application Publication
(10) Pub. No.: US 2012/0193494 A1
(43) Pub. Date: Aug. 2, 2012

(54) Telescopic clamp

(76) Inventor: Gabriel Popescu, Burlington (CA)

(21) Appl. No.: 13/385,976

(22) Filed: Mar. 19, 2012

(30) Foreign Application Priority Data
Jun. 14, 2010 (CA) 2706989

(51) Int. Cl. F16B 2/12

(52) U.S. Cl. 248/274.1

(57) ABSTRACT

A telescopic pipe clamp designed to fastening short or long work pieces with the same tool.

The clamp includes:
Two pipes. The first one carries a fixed jaw. The second one, which has the interior dimensions slight larger than first pipe in order to can slide along it, carries a movable jaw.
Both pipes have the holes drilled at the same alignment.
A pin to be inserted through above mentioned holes in order to secure the pipes together.

### SUMMARY OF THE INVENTION

The object of this invention, as it will become clear in this description and accompanied drawings, is to provide a telescopic pipe clamp that can be used to hold any size of work pieces.

Two square pipes compose the proposed embodiment of telescopic clamp (A, B FIG. 4,5).

First pipe (A), which carries a fixed jaw (A1 FIG. 4,5), has holes drilled on its flanks at the same alignment and distance.

The second pipe (B) has the interior dimensions slightly larger than the first one's exterior, in order to slide along it and has two pair of holes, at each end, at the same alignment with the holes of first pipe. That second pipe carries a second, movable, jaw (B1 FIG. 4, 5) securable along it and opposite to the fixed jaw of the first pipe.

A pin (C, FIG. 4, 5) is inserted through both pipes holes, in order to secure them together.

By coupling more than two pipes will be possible to arrive at any desiderate length (FIG. 6).

### BACKROUND OF THE INVENTION

Bar or pipe clamps are widely used by woodworkers and craftsmen, but not only. Metal workers use also clamps, and Do-It-Yourself enthusiasts need clamps on their work.

They, all, have the same problem: for large work pieces, they need long clamps. A long clamp can be used, also, for short pieces, but with all inconveniences derived.

In order to cover all situations, they need a large number of clamps, which—especially (but not only) for DIY enthusiasts means money and storage space.

The problem is not new, as other inventors tried to solve it: US 007322571, CA 2589417 (SPRINGER, SCOTT D.).

The object of present invention is to provide a telescoping pipe clamp, which can be used for short or long pieces either.

### DESCRIPTION OF THE DRAWINGS

FIG. 1 depicts a perspective view of a traditional pipe clamp, available at any store. It appears clear that the length of pipe limits the length of work piece to be held.

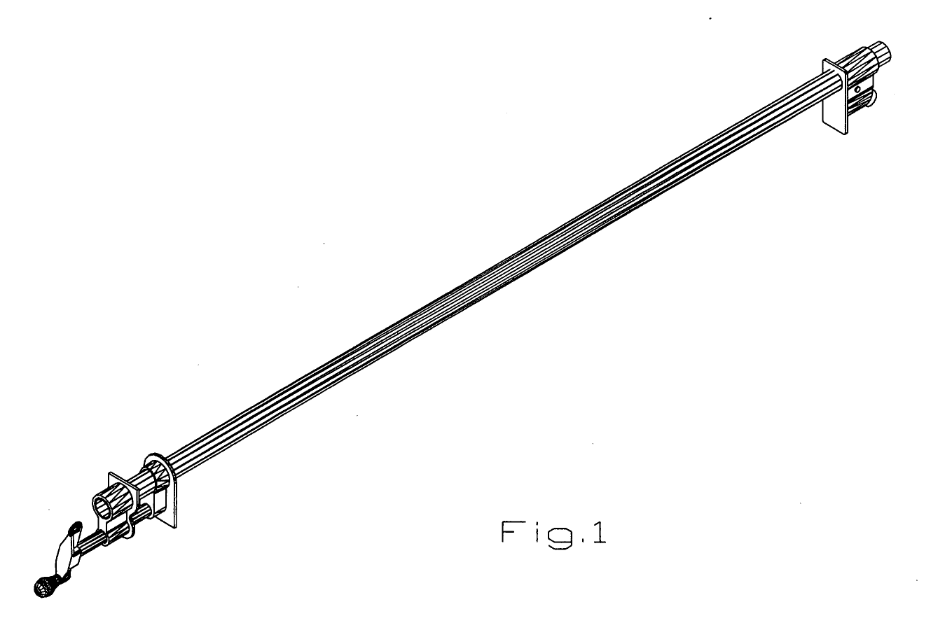

FIG. 2 is a perspective view of the present invention's embodiment.

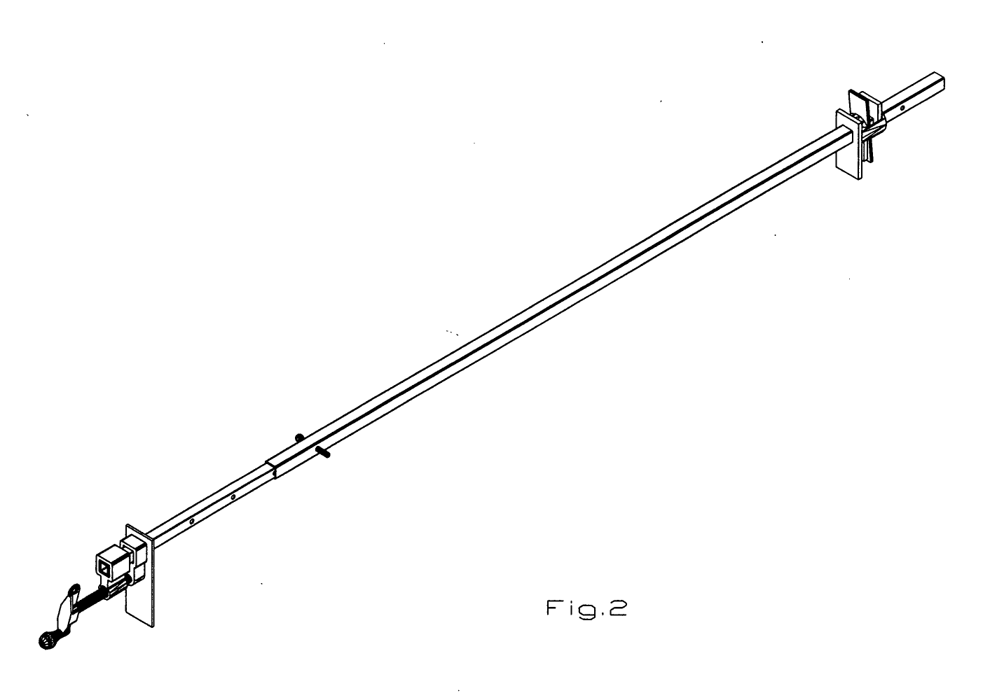

FIG. 3 illustrates the advantages of the proposed invention. It is a perspective view of two possible utilisation of it.

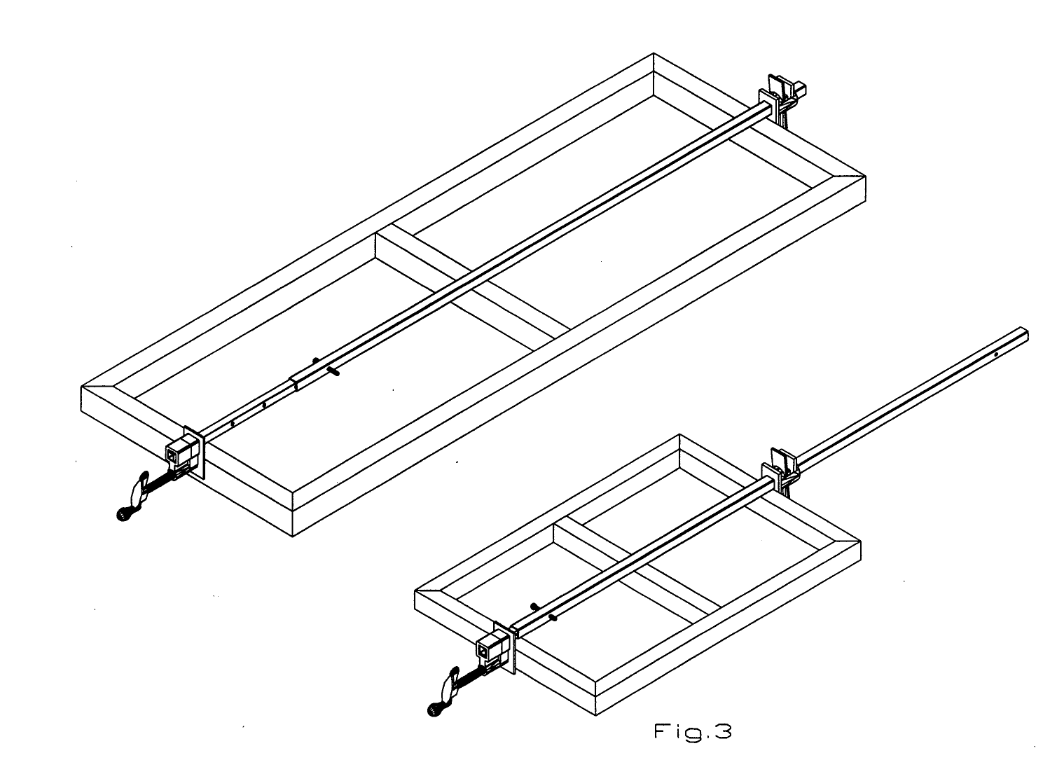

FIG. 4 is a detailed perspective of the proposed invention. It appears clear the first pipe—A which carries the fixed jaw—A1, the second pipe—B carrying the movable jaw—B1, and the pin C inserted trough both pipe holes.

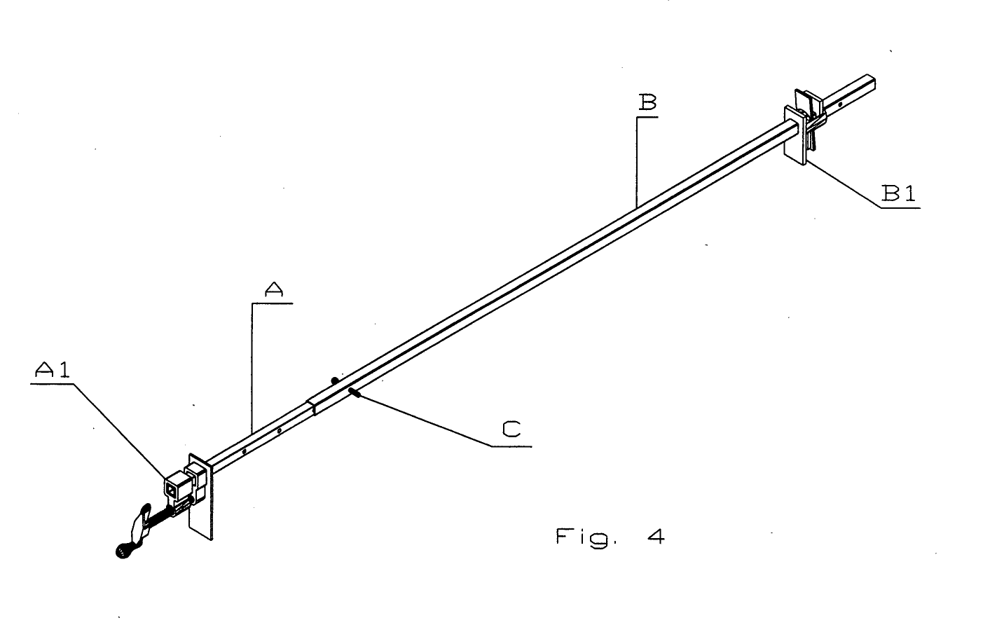

FIG. 5 represents in perspective the two component pipes of the proposed invention, each of them carrying the respective jaw, and the pin.

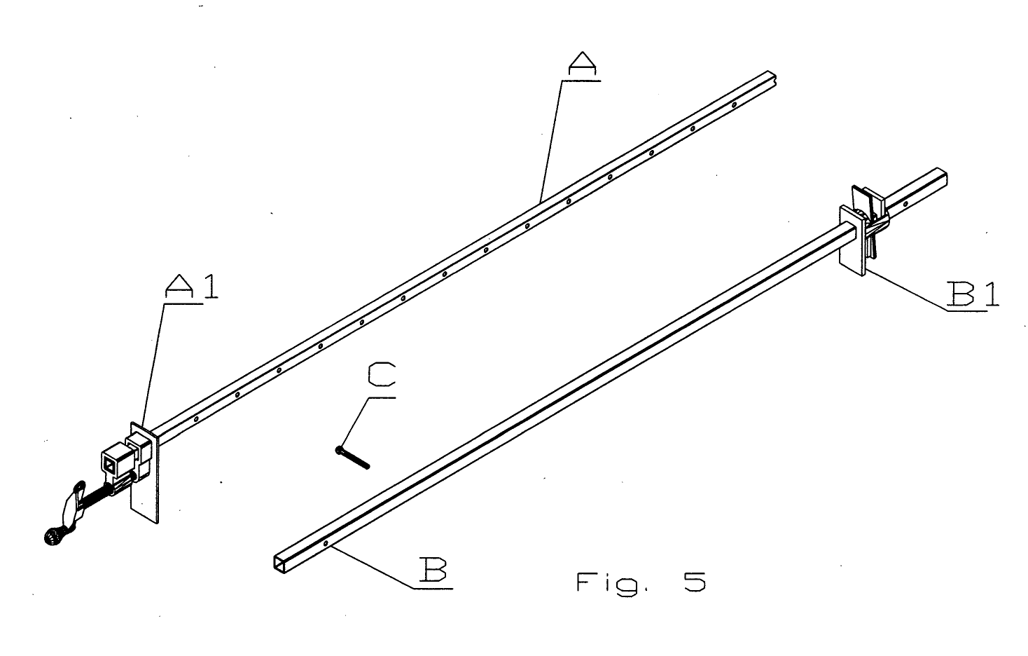

FIG. 6 shows the possibility to arrive at an even larger length by coupling more than two pipes.

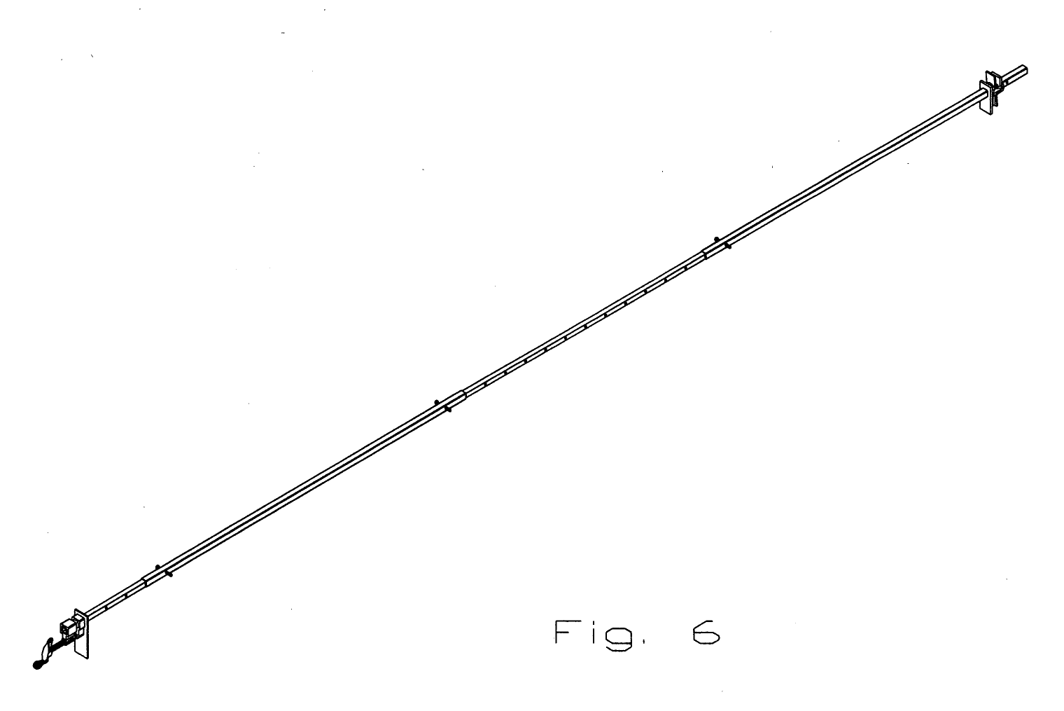

What is claimed:

1. A telescopic clamp composed of two pipes: first pipe carries a jaw secured at its end, the second pipe which has the interior section slightly larger than the first one's exterior in order to slide along it, carries a movably securable jaw in position opposite to fixed jaw.

2. The clamp of claim #1 where the pipes have a section round, square, rectangle, etc.

3. The clamp of claim #2 where the pipes have holes driven on their flanks at the same distance and the same alignment, as a pin can be inserted trough both pipe holes in order to secure them together.

4. The clamp of claim #3 where the distance between holes is in accordance with the length of the fixed jaw's tread in order to permit an accurate position for holding work pieces.
